(19) United States
(12) Patent Application Publication
(10) Pub. No.: US 2010/0220013 A1
(43) Pub. Date: Sep. 2, 2010

(54) POSITIONING SYSTEM

(75) Inventors: Nobuhiro SUZUKI, Tokyo (JP); Hisakazu Maniwa, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: MITSUBISHI ELECTRIC CORPORATION, Tokyo (JP)

(21) Appl. No.: 12/505,769

(22) Filed: Jul. 20, 2009

(30) Foreign Application Priority Data
Mar. 2, 2009 (JP) 2009-048175

(51) Int. Cl. G01S 5/04

(52) U.S. Cl. 342/442

(57) ABSTRACT

A high-precision positioning system including: a radio source (1) that transmits radio waves each having a plurality of different frequencies; receivers (2-4) for receiving radio waves from the radio source, calculators (5) for calculating phase differences of the received radio waves of the respective frequencies between the receivers, calculators (6,7) for calculating an arrival time difference between the rceivers from the phase difference of the respective frequencies calculated by the (5), and calculators (8) for calculating the positioning of the (1) from the combination of the arrival time differences calculated by the (6,7), wherein the transmit frequencies from the (1) include frequencies arranged such that a frequency difference of two frequency waves arbitrarily selected is an integral multiple of a smallest frequency difference, the frequency difference does not overlap with the frequency difference of two frequency waves of other combinations, and a largest frequency difference of the frequency difference is narrowest.

### BACKGROUND OF THE INVENTION

1. Field of the Invention

The present invention relates to a positioning system, and more particularly, to a positioning system that performs positioning by using a phase difference of radio waves.

2. Description of the Related Art

A technique for positioning the phase difference of radio waves is advantageous in that positioning can be made with high precision of about a several tenth part of wavelengths, irrespective of a signal band width. However, because of uncertainty of the phase integer value which derives from a wavelength cycle, there is a need to decide the phase integer value through some method.

As the method, there has been known, for example, a kinematic GPS (GPS using the carrier phase of radio waves), in which a rough position is first obtained by using an arrival time difference of modulated signals, the candidates for the phase integer values are narrowed down, and thereafter a final real solution is obtained by using a fact that a real solution does not travel whereas a false solution travels as a satellite travels.

Also, JP 2001-272448 A (Page 6, FIG. 1) discloses a method in which an initial position is obtained by another method to decide the phase integer value in advance, and thereafter the phase difference corresponding to the traveling quantity is added to the phase integer value to calculate the positioning. Also, the publication discloses a method which employs two frequency waves to facilitate the decision of the phase integer value by using.

Among the above-mentioned conventional systems, the system thatch uses in combination the time difference positioning requires a transceiver of a broadband, resulting in such a drawback that the system is complicated and expensive. Alternatively, the system of measuring the initial position through another method as disclosed in JP 2001-272448 A cannot be applied to a case in which no initial position cannot be measured, resulting in such a problem that the initial position measurement itself troublesome. In the system using two frequency waves, it is easy to decide the phase integer value, but the decision of the phase integer value cannot be insured in the system itself, which leads to a problem that the system needs to be used in combination with another system.

### SUMMARY OF THE INVENTION

The present invention has been made to solve the above-mentioned problem, and therefore has an object to provide a positioning system that enables high-precision positioning.

The present invention relates to a positioning system, which includes: a radio source for transmitting radio waves each having a plurality of different frequencies; a plurality of receivers for receiving radio waves from the radio source, the positions of the plurality of receivers being known; phase difference calculators for calculating phase differences of the received radio waves of the respective frequencies between the respective receivers; arrival time difference calculators for calculating an arrival time difference between the respective receivers from the phase difference of the respective frequencies calculated by the phase difference calculators; and positioning calculators for calculating the positioning of the radio source from a combination of the arrival time differences calculated by the arrival time difference calculators. In the positioning system, the plurality of different transmit frequencies from the radio source include frequencies arranged such that a frequency difference of two frequency waves arbitrarily selected is an integral multiple of a smallest frequency difference, the frequency difference does not overlap with the frequency difference of two frequency waves of other combinations, and a largest frequency difference of the frequency difference is narrowest.

According to the present invention, in the phase different positioning system, the phase integer value is reliably determined, thereby enabling high-precision positioning.

### BRIEF DESCRIPTION OF THE DRAWINGS

In the accompanying drawings:

FIG. 1 is a configuration diagram illustrating an example of the configuration of a positioning system according to the present invention;

FIG. 2 is a flowchart of the operation for searching for a pair of transmit frequencies according to the present invention;

FIG. 3 is a diagram for explaining a pair of frequencies in which a maximum frequency related to the pair of transmit frequencies is lowest and there is no overlap of a frequency difference in all combinations of two frequency waves according to the present invention; and

FIGS. 4A to 4I are diagrams for explaining a first evaluation function according to the present invention.

### DETAILED DESCRIPTION OF THE PREFERRED EMBODIMENTS

Hereinafter, a description is given of a positioning system according to various embodiments of the present invention with reference to the accompanying drawings.

### Embodiment 1

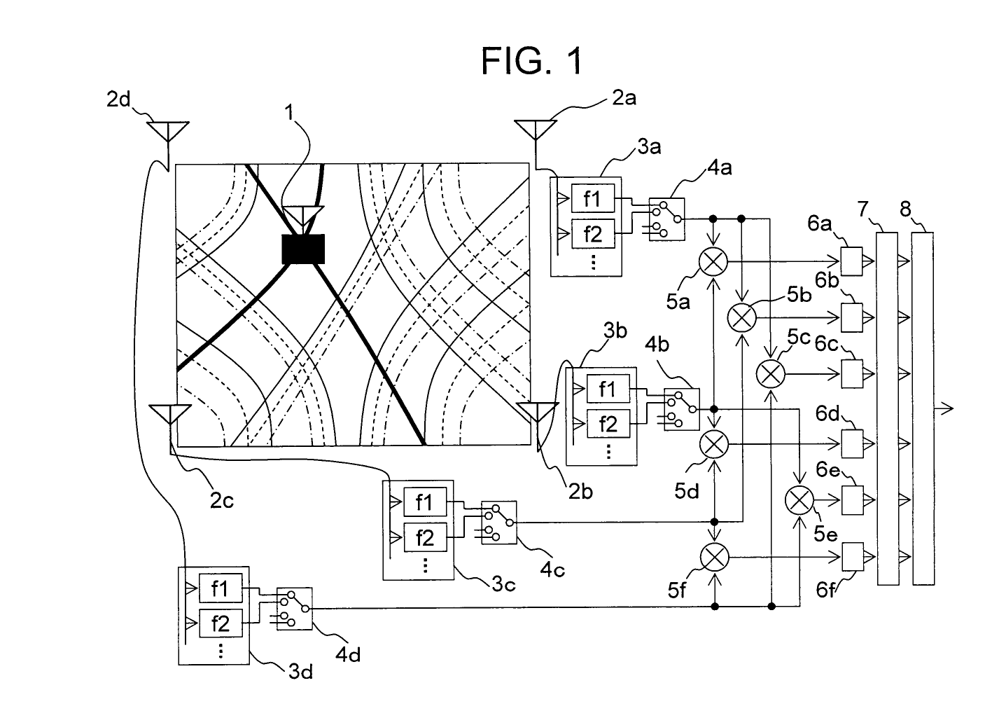

FIG. 1 is a configuration diagram illustrating an example of the configuration of a positioning system according to the present invention. Reference numeral 1 denotes a transmitter being a radio source, 2a to 2d are receiving antennas, 3a to 3d are filter banks, 4a to 4d are changeover switches, 5a to 5f are phase difference calculators (phase difference calculating means), 6a to 6f are arrival time difference candidate calculators (arrival time difference candidate calculating means), 7 is an arrival time difference candidate selector (arrival time difference candidate selecting means), and 8 is a positioning calculator (positioning calculating means). The arrival time difference candidate calculators 6a to 6f and the arrival time difference candidate selector 7 constitute an arrival time difference calculating unit (arrival time difference calculating means). In FIG. 1, there are provided four receivers each including, for example, a receiving antenna (2), a filter bank (3), and a changeover switch (4).

Subsequently, the operation is described. The transmitter 1 to be positioned has a mechanism for changing a transmit frequency, and changes the transmit frequency to a given frequency determined through a method which is described later every given period of time to transmit an radio wave. The receiving antennas 2a, 2b, 2c, and 2d in the respective receivers receive radio waves from the transmitter 1, and input the received radio waves to the filter banks 3a to 3d. The filter banks 3a to 3d are each made up of a plurality of band pass filters (referred to as f1, f2, . . . ) having a plurality of respective frequencies transmitted by the transmitter 1 as center frequencies.

The changeover switches 4a to 4d change over every time the transmitter 1 changes the frequency as described above, to select outputs of the band pass filters each having the above frequency. Signals from which only signal components from the transmitter 1 are extracted by the band pass filters are input to the phase difference calculators 5a to 5f to calculate receive phase differences between all of paired receivers. Also, the receive phase differences are calculated every time the transmitter 1 changes the frequency, and all of the frequencies which are transmitted by the transmitter 1 are calculated.

The frequency is sequentially changed over to acquire the phase differences of the plurality of frequencies as described above, resulting in such an advantage that the structure of the transceiver mechanism of radio waves can be simplified.

As a method of acquiring the phase difference of the plurality of frequencies, a method of acquiring the phase difference of the plurality of frequencies at the same time may be applied by using a transmitter with a mechanism that transmits the plurality of frequencies at the same time and a receiver with a mechanism that receives the plurality of frequencies at the same time. That method is advantageous in that measurement for positioning is made in a short time.

In any event, the use of the phase differences of the plurality of frequencies at given frequency intervals is the nature of the present invention, and a method of determining the given frequency interval is described later.

Subsequently, the arrival time difference candidate calculators 6a to 6f accumulate the receive phase differences of the respective pairs of receivers with respect to all of the frequencies, and calculate a plurality of arrival time difference candidates among the receivers. This is conducted by arbitrarily setting t (estimation arrival time difference) by which a first evaluation function represented in the following Expression (1) is maximized with respect to the respective pairs of receivers, for searching for t.

$$\begin{matrix}[ Ex . 1 ] & \\ {F}_{m , n} ( t ) = {\vert {\sum }_{k = 1}^{K} exp ( j {φ}_{k , m , n} - 2 jπ {f}_{k} t ) \vert}^{2} \\ ( m = 1 , 2 , … , M , n = 1 , 2 , … , M ) & ( 1 )\end{matrix}$$

In Expression (1), fₖ is a k-th transmit frequency, φ_{k, m, n} is a receive phase difference calculated between a receiver #m and a receiver #n in a k-th frequency, K is the number of all frequencies, and M is the number of all receivers. The absolute value indicates a phase vector sum.

The reason that the arrival time difference candidates can be obtained by the evaluation function of Expression (1) is as follows.

When there is no observation error in the receive phase difference, φ_{k, m, n,} is represented by the following Expression (2).

[Ex. 2]

φ_{k,m,n}=2jπfₖτ_{m,n} (2)
(k=1, 2, . . . , K, m=1, 2, . . . , M, n=1, 2, . . . , M)

In Expression (2), τ_{m, n} is an arrival time difference between the receiver #m and the receiver #n.

From Expression (2), the first evaluation function of Expression (1) is a maximum K² when t=τ_{m, n}. Accordingly, t by which the evaluation function is maximum within a prediction range of the arrival time difference which is predicted from the positioning range is searched for, thereby enabling the arrival time difference τ_{m, n} between the receiver #m and the receiver #n to be obtained. However, in fact, since the first evaluation function may have a plurality of maximums, a plurality of ts having the maximum larger than a given value are regarded as the arrival time difference candidates.

Subsequently, in the arrival time difference candidate selector 7, the appropriate combination of the arrival time difference candidates is selected from the arrival time difference candidates between the respective receivers. This is conducted by substituting the arrival time difference candidates for a second evaluation function represented by the following Expression (3), and searching for the combination of the arrival time difference candidates that minimize the second evaluation function.

$$\begin{matrix}[ Ex . 3 ] & \\ G ( {τ}_{1 , 2} , {τ}_{1 , 3} , … , {τ}_{1 , M} , {τ}_{2 , 3} , {τ}_{2 , 4} , … , {τ}_{2 , M} , … , {τ}_{M - 1 , M} ) = {\sum }_{m = 1}^{M} {\sum }_{n = m + 1}^{M} {\sum }_{p = n + 1}^{M} {\vert {τ}_{m , n} + {τ}_{n , p} - {τ}_{m , p} \vert}^{2} & ( 3 )\end{matrix}$$

The reason that the second evaluation function in Expression (3) is minimum at the time of combining the appropriate arrival time difference candidates together is because when all of the arrival time differences τ_{m, n}, τ_{n, p}, and τ_{m, p} are true values, a relational expression of the following Expression (4) is established.

[Ex. 4]

τ_{m,n}+τ_{n,p}−τ_{m,p}=0 (4)
(m=1,2, . . . ,M, n=1,2, . . . ,M, p=1,2, . . . ,M)

Accordingly, the combination of the arrival time difference candidates in which Expression (3) being a square sum of all the combinations of Expression (4) which is an expression related to three receivers is minimum can be estimated as the most probable candidates.

Subsequently, the positioning calculator 8 calculates positioning by using the combination of the most probable candidates for arrival time difference to obtain the position of the transmitter 1. The positioning calculation is performed by solving a simultaneous equation of the arrival time differences of all the pairs of receivers, which are represented by the following Expression (5).

$$\begin{matrix}[ Ex . 5 ] & \\ {τ}_{m , n} = \frac{1}{c} \sqrt{\begin{matrix}\begin{matrix}{( x - {X}_{m} )}^{2} + \\ {( y - {Y}_{m} )}^{2} +\end{matrix} \\ {( z - {Z}_{m} )}^{2}\end{matrix}} - \frac{1}{c} \sqrt{\begin{matrix}\begin{matrix}{( x - {X}_{n} )}^{2} + \\ {( y - {Y}_{n} )}^{2} +\end{matrix} \\ {( z - {Z}_{n} )}^{2}\end{matrix}} & ( 5 )\end{matrix}$$

(m=1,2, . . . ,M, n=1,2, . . . ,M)

In Expression (5), Xₘ, Yₘ, Zₘ, and Xₙ, Yₙ, Zₙ are positions of the receiver #m and the receiver #n, respectively, all of which are known values. Also, c corresponds to the speed of light, and x, y, and z are positions of the transmitter 1 to be obtained.

Because the equation of Expression (5) is a nonlinear equation, the equation is solved by numeric calculation such as successive approximation. Because three variables are unknown, namely, x, y, and z, three or more independent equations are required to solve the equation, and at least four receivers are required.

When there are four receivers or more, the equation is solved by using a least squares method. In this case, the square residual error can be also regarded as the evaluation function of the arrival time difference candidate selection. In the arrival time difference candidate selector 7, the combinations of the plurality of arrival time difference candidates are reserved to perform the positioning calculation with respect to the respective combinations, and the transmitter position obtained by using the combination of the arrival time difference candidates whose square residual error is smallest can be regarded as the most probable transmitter position. Further, the sum of the square residual error of the equation and Expression (3) can be set as the evaluation function of the arrival time difference candidate selection.

When a position within a two-dimensional plane is merely required as the positioning result, an assumed value is substituted for the height z of the transmitter 1, which reduces the number of the unknown variables to two, that is, x and y, and therefore, positioning can be performed by only three receivers. Also, when there are four or more receivers, the square residual error can be set as the evaluation function of the arrival time difference candidate section as in the case of the above-mentioned three-dimensional positioning.

The most significant feature of the present invention resides in the method of determining the frequency interval of the plurality of transmit frequencies. The reason that the plurality of frequencies are used is to decide the phase integer value. Therefore, in order to perform positioning in a minimum measurement time, it is desirable that the phase integer value be decided by the smallest number of frequencies. This frequency arrangement is suggested because the first evaluation function of Expression (1) can be developed as represented by the following Expression (6).

$$\begin{matrix}[ Ex . 6 ] & \\ {F}_{m , n} ( t ) = K + {\sum }_{k = 1}^{K} {\sum }_{l = k + 1}^{K} exp \{ \begin{matrix}j ( {φ}_{k , m , n} - {φ}_{l , m , n} ) - \\ 2 jπ ( {f}_{k} - {f}_{l} ) t\end{matrix} \} + {\sum }_{k = 1}^{K} {\sum }_{l = k + 1}^{K} exp \{ \begin{matrix}- j ( {φ}_{k , m , n} - {φ}_{l , m , n} ) + \\ 2 jπ ( {f}_{k} - {f}_{l} ) t\end{matrix} \} & ( 6 )\end{matrix}$$

The evaluation function suitable for uncertainty exclusion of the phase integer value is required to meet the following conditions:

(1) there is no maximum having a large value, except for a real arrival time difference; and

(2) a peak width of the maximum in the real arrival time difference is narrow.

The function that ideally meets the above two conditions is a Dirac delta function which is represented by the following Expression (7).

$$\begin{matrix}[ Ex . 7 ] & \\ δ ( t - τ ) = {\sum }_{k = - ∞}^{∞} exp \{ 2 jπ kf τ - 2 jπ kf t \} & ( 7 )\end{matrix}$$

When Expression (6) is compared with Expression (7), it is understood that, for the evaluation function of Expression (6), the frequency difference fₖ−f₁ of two arbitrary frequency waves are desired to include the frequency components of the number as large as possible, and those frequency components desired to be uniformly distributed. That is, when the frequency difference fₖ−f₁ of all the combinations of two frequency waves are arranged in ascending order, those frequency differences each are an integral multiple of the frequency f, that is, the pair of frequencies being fₖ (k is an integer) is a pair of frequencies suitable for the uncertainty exclusion of the phase integer value.

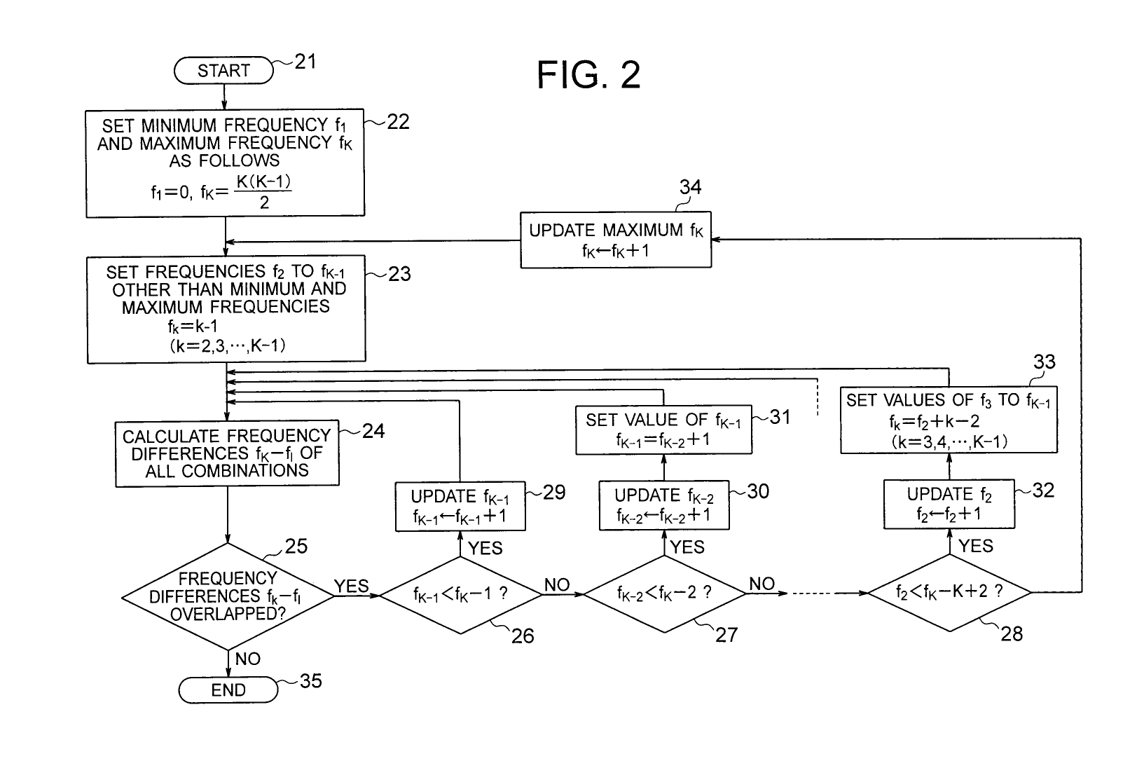

A method of searching for the above-mentioned pair of frequencies is described below. FIG. 2 is an operation flowchart for searching for the above-mentioned pairs f₁, f₂, . . . f_{K} (here, f₁<f₂< . . . <f_{K}) of the frequencies when the number of frequencies is K. Searching for the pairs of frequencies is executed by a computer, such as a computer additionally provided, or a control computer (both are not shown) provided to the transmitter 1.

Processing starts in Step 21, and initial values of f₁ and f_{K} are first set in Step 22. Because only the interval of the frequencies has significance, the lowest frequency f₁ is set to 0. Also, because the number of combinations of arbitrary two frequency waves is K(K−1)/2, in the most ideal case, that is, when all of the frequency differences including 1 to K(K−1)/2 are obtained, the maximum frequency difference is K(K−1)/2, which occurs between f₁ and f_{K}. Therefore, f_{K} is set to K(K−1)/2.

Then, in Step 23, the smallest value that can be taken by f₂ to f_{K-1} is set. This is realized by incrementing the frequency fₖ to be set one by one from an adjacent frequency fₖ₋₁.

After all of the frequencies f₁, f₂, . . . , f_{K} have been thus set, the frequency differences fₖ−f₁ of all the combinations of two frequency waves are calculated in Step 24.

In Step 25, it is checked whether or not there is an overlap of those frequency differences, and when there is no overlap, the pairs f₁, f₂, . . . , f_{K} of those frequencies are the frequency intervals to be obtained. Therefore, processing is advanced to Step 35, and the calculation is completed.

Also, when there is an overlap of those frequency differences in Step 25, processing is advanced to Steps 26 to 28, and any one of the frequencies f₂ to f_{K-1} is changed. In Step 26, it is checked whether or not f_{K-1} can take a larger value. When f_{K-1} is smaller than f_{K}−1, f_{K-1} can take a larger value, and therefore the processing is advanced to Step 24, where the frequency differences of all the combinations of two frequency waves are calculated. Then, in Step 25, it is checked whether or not there is an overlap of the frequency difference.

As described above, f_{K-1} is incremented one by one so far as there is an overlap of the frequency difference, and the value becomes equal to f_{K-1} at some stage. Therefore, processing is advanced from Step 26 to Step 27, and it is then checked whether or not f_{K-2} can take a larger value. When f_{K-2} is smaller than f_{K}−2, f_{K-2} can take a larger value, and therefore the processing is advanced to Step 30, where 1 is added to f_{K-2}. Then, in Step 31, f_{K-1} is set to f_{K-2}+1 being the smallest value taken by f_{K-1}, which is set as the pairs f₁, f₂, . . . f_{K} of new frequencies. The processing is again returned to Step 24 with the pairs of new frequencies, where the frequency differences of all the combinations of two frequency waves are again calculated. Then, in Step 25, it is checked whether or not there is an overlap of the frequency difference.

As described above, f_{K-2} is also incremented one by one so far as there is an overlap of the frequency difference, and the value becomes equal to f_{K}−2 at some stage. Therefore, it is then checked whether or not f_{K-3} takes a larger value, and the combination of new frequencies is searched for in the same manner. Thus, since f₂ is also incremented one by one, it is checked whether or not f₂ can take a larger value in Step 28. When f₂ is smaller than f_{K}−K+2, the processing is advanced to Step 32, and 1 is added to f₂. Then, in Step 33, f₃ to f_{K-1} are set to f₂+k−2 (k=3, 4, . . . , K−1) which are the smallest value taken by f₃ to f_{K-1}, respectively. The processing is returned to Step 24 with the pairs of the frequencies f₁, f₂, . . . , f_{K}, and the frequency differences of all the combinations of two frequency waves are again calculated, and in Step 25, it is checked whether or not there is an overlap of the frequency difference.

Finally, f₂ becomes f_{K}−K+2, and at a time point when no larger value can be taken, the processing is advanced from Step 28 to Step 34, where f_{K} being the maximum frequency is incremented by one, and the processing is returned to Step 23 to repeat the above search.

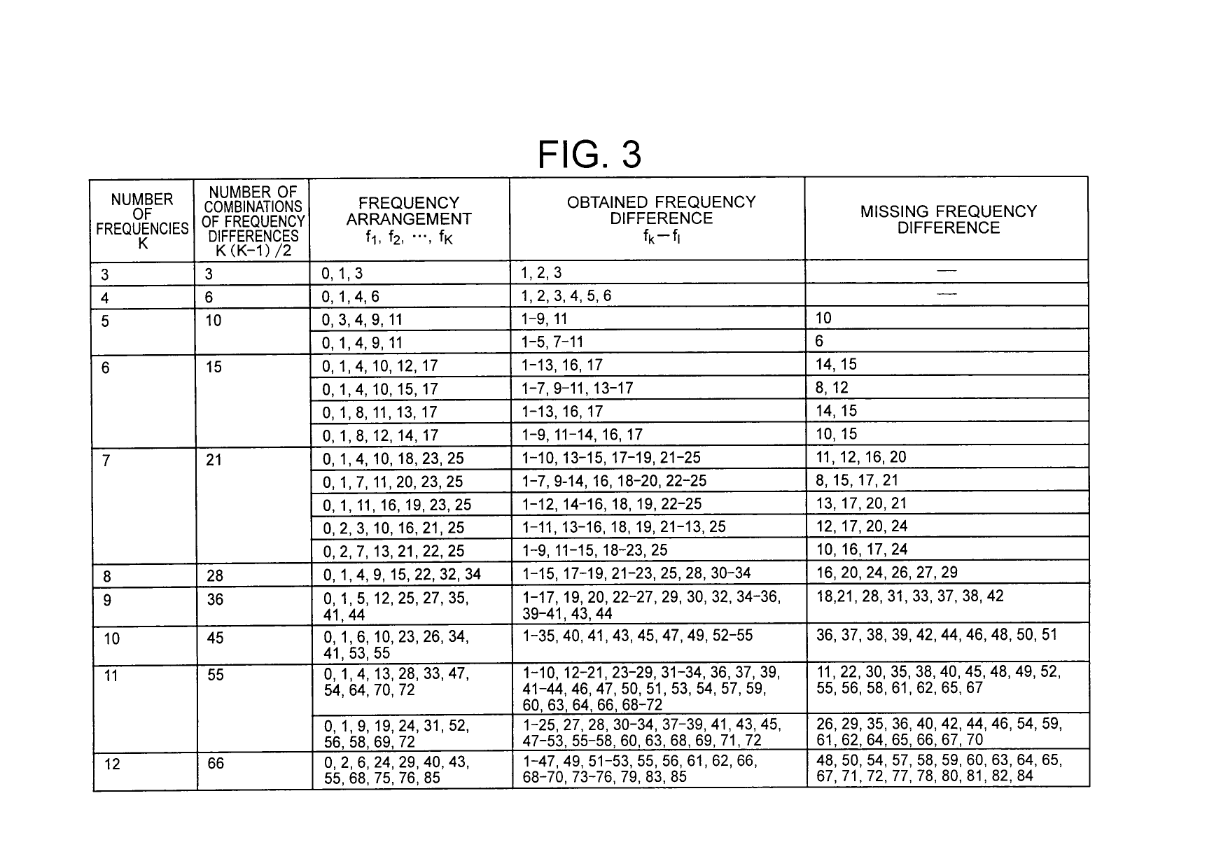

Through the above search, the pairs f₁, f₂, . . . , f_{K} of the frequencies where the maximum frequency f_{K} is smallest, and there is no overlap of the frequency differences of all the combinations of two frequency waves can be reteieved. One example thereof is illustrated in FIG. 3. For example, in the case of four waves, f₁=0, f₂=1, f₃=4, and f₄=6 are set to obtain six frequency differences of 1 to 6. When K is 5 or more, a missing frequency difference occurs. However, there arises no serious problem as is described later.

For simplification of description, the simplest system for searching all the cases is described above. However, the searching time can be quickened by refining the search range of f₁ to f_{K}. However, the obtained results are identical with those illustrated in FIG. 3 regardless of the searching method. Accordingly, any method may be applied as the searching method itself.

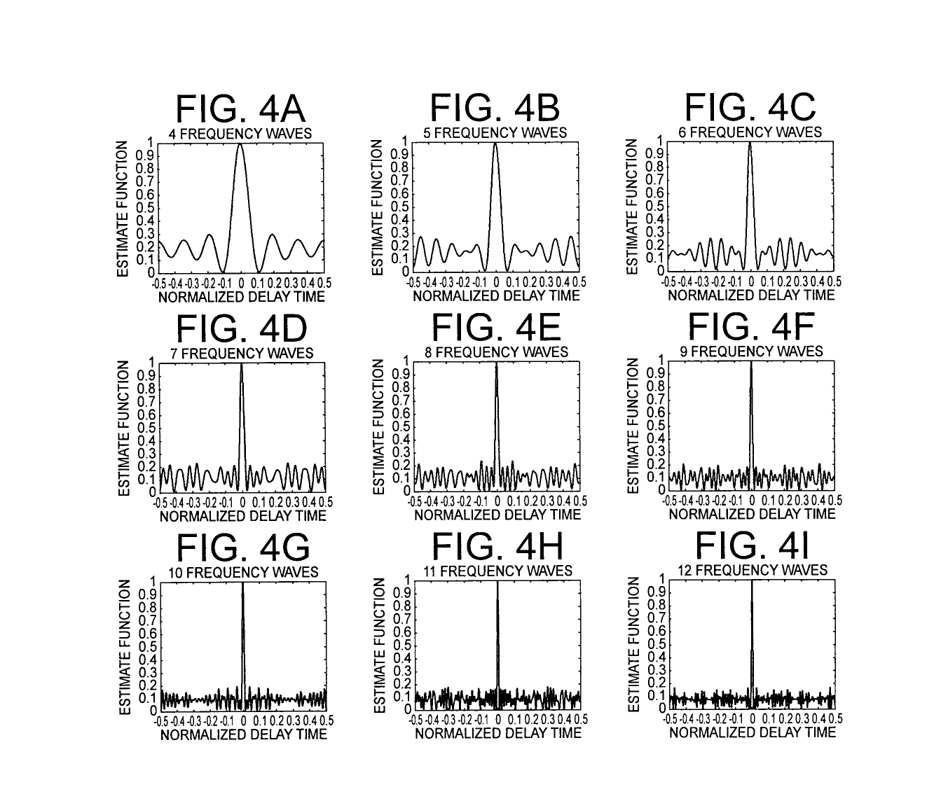

Assuming that there is no error in the observation phase which is obtained by using the pairs of those frequencies and the real arrival time difference is 0, the first evaluation function of the Expression (1) calculated is illustrated in FIGS. 4A to 4I. The axis of ordinate in each of FIGS. 4A to 4I represents evaluation function, and the axis of abscissa represents a normalized delay time. As described above, there is a missing frequency difference when K is 5 or more as described above, but as illustrated in FIGS. 4A to 4I, it is found that the peak width of the real arrival time difference is narrower as the number of frequencies increases, and the maximum other than the real arrival time difference also decreases. Accordingly, as the number of frequencies increases, the uncertainty is more easily to be excluded, and the positioning precision is also made higher.

Since the pairs of frequencies illustrated in FIG. 3 means only the intervals of the frequencies, the real frequencies are set to f₁=300 MHz, f₂=301 MHz, f₃=304 MHz, and f₄=306 MHz when, for example, the number of frequencies is 4, the lowest carrier frequency is 300 MHz, and the smallest frequency difference is 1 MHz.

In this example, attention should be paid to the fact that the inverse of the smallest frequency difference falls within the arrival time difference range ensuring that no uncertainty occurs. For example, when the smallest frequency difference is 1 MHz, the arrival time difference range where no uncertainty occurs is 0 to 1μ seconds (converted to 0 to 300 m in distance), or ±0.5μ seconds (converted to ±150 m in distance) centered on 0. That is, the arrival time difference range where no uncertainty occurs increases as the smallest frequency difference decreases. Accordingly, the arrival time difference range expected from the size of the positioning area is determined, and the smallest frequency difference is determined according to that range, thereby ensuring that no uncertainty occurs in the positioning area.

On the other hand, the measurement precision of the arrival time difference is such that the real arrival time difference is higher in precision as the peak width is narrower, and the peak width is substantially in proportion to the inverse of the largest frequency difference. That is, it is desirable that the largest frequency difference is larger from the viewpoint of the measurement precision. In other words, high measurement precision with keeping the broad positioning area can be obtained by increasing the number of frequencies, reducing the smallest frequency difference, and increasing the largest frequency difference. Also, when the required positioning range and the required measurement precision are set, the required largest frequency difference and the smallest frequency difference can be obtained to determine the smallest number of frequencies.

As a specific example, f₁=0 Hz may be set in the real frequency. In this case, it is only necessary that the observation phase difference φ_{1, m, n} f₁ be set to 0, and real observation is unnecessary. Also, other frequencies are determined so that no uncertainty occurs in the smallest frequency difference as in the cases other than the case of f₁=0 Hz, and the largest frequency difference f_{K}−f₁, that is, the maximum frequency f_{K} is so determined as to attain a required positioning precision.

As described above, according to this embodiment, the positioning calculation is executed by using the phase differences of the plurality of frequencies at the frequency intervals which have the smallest frequency difference where no phase uncertainty occurs in the measurement area and the maximum frequency difference required to attain the required measurement precision, and there is no overlap between the frequency differences of respective two arbitrary frequency waves. As a result, there can be realized a high-precision positioning system which is low in phase uncertainty by using the smallest number of frequencies.

Also, since the arrival time difference candidates are selected by using the above specific frequency interval as well as the second evaluation function of Expression (3), the possibility that the phase decision is in error can be reduced.

### Embodiment 2

In Embodiment 1, the arrival time difference is estimated with Expression (1) having the sensitivity in the phase difference of the frequency difference as the evaluation function. On the other hand, in this embodiment, the arrival time difference is estimated with the following Expression (8) as the first evaluation function instead of Expression (1).

$$\begin{matrix}[ Ex . 8 ] & \\ {F}_{m , n} ( t ) = {\vert 1 + {\sum }_{k = 1}^{K} exp ( j {φ}_{k , m , n} - 2 jπ {f}_{k} t ) \vert}^{2} \\ ( m = 1 , 2 , … , M , n = 1 , 2 , … , M ) & ( 8 )\end{matrix}$$

Since all of parts other than the arrival time difference estimation are identical with those in Embodiment 1, their description is omitted.

Then, the advantages of this embodiment are described. Expression (8) can be developed as the following Expression (9).

$$\begin{matrix}[ Ex . 9 ] & \\ {F}_{m , n} ( t ) = K + 1 + {\sum }_{k = 1}^{K} {\sum }_{l = k + 1}^{K} exp \{ \begin{matrix}j ( {φ}_{k , m , n} - {φ}_{l , m , n} ) - \\ 2 jπ ( {f}_{k} - {f}_{l} ) t\end{matrix} \} + {\sum }_{k = 1}^{K} {\sum }_{l = k + 1}^{K} exp \{ \begin{matrix}- j ( {φ}_{k , m , n} - {φ}_{l , m , n} ) + \\ 2 jπ ( {f}_{k} - {f}_{l} ) t\end{matrix} \} + {\sum }_{k = 1}^{K} exp \{ {jφ}_{k , m , n} - 2 jπ {f}_{k} t \} + {\sum }_{k = 1}^{K} exp \{ - {jφ}_{k , m , n} + 2 jπ {f}_{k} t \} \\ ( m = 1 , 2 , … , M , n = 1 , 2 , … , M ) & ( 9 )\end{matrix}$$

When Expression (9) is compared with Expression (6), it is understood that not only the frequency difference component fₖ−f₁ (k, 1=1, 2, . . . , K) of the third term and the fourth term at the right hand of the expression, but also the direct carrier frequency component fₖ (k=1, 2, . . . , K) of the fifth term and the sixth term are included.

As described above, according to this embodiment, the direct carrier frequency component is added to the evaluation function in addition to the frequency difference component, which increases the number of frequency components to be included. For this reason, it is expected that the phase uncertainty be advantageously excluded, and the arrival time difference can be estimated with higher precision.

### Embodiment 3

In Embodiment 1, the arrival time difference is estimated with Expression (1) having the sensitivity in the phase difference of the frequency difference as the evaluation function. On the other hand, in this embodiment, the arrival time difference is estimated with the following Expression (10) as the evaluation function instead of Expression (1).

$$\begin{matrix}[ Ex . 10 ] & \\ {F}_{m , n} ( t ) = {\vert \begin{matrix}{\sum }_{k = 1}^{K} exp ( - j {φ}_{k , m , n} + 2 jπ {f}_{k} t ) + \\ {\sum }_{k = 1}^{K} exp ( j {φ}_{k , m , n} - 2 jπ {f}_{k} t )\end{matrix} \vert}^{2} \\ ( m = 1 , 2 , … , M , n = 1 , 2 , … , M ) & ( 10 )\end{matrix}$$

Since all of parts other than the arrival time difference estimation are identical with those in Embodiment 1, their description is omitted.

Then, the advantages of this embodiment are described. Expression (10) can be developed as the following Expression (11).

$$\begin{matrix}[ Ex . 11 ] & \\ {F}_{m , n} ( t ) = 2 K + {\sum }_{k = 1}^{K} {\sum }_{l = k + 1}^{K} exp \{ \begin{matrix}j ( {φ}_{k , m , n} - {φ}_{l , m , n} ) - \\ 2 jπ ( {f}_{k} - {f}_{l} ) t\end{matrix} \} + {\sum }_{k = 1}^{K} {\sum }_{l = k + 1}^{K} exp \{ \begin{matrix}- j ( {φ}_{k , m , n} - {φ}_{l , m , n} ) + \\ 2 jπ ( {f}_{k} - {f}_{l} ) t\end{matrix} \} + {\sum }_{k = 1}^{K} {\sum }_{l = k + 1}^{K} exp \{ \begin{matrix}j ( {φ}_{k , m , n} + {φ}_{l , m , n} ) - \\ 2 jπ ( {f}_{k} + {f}_{l} ) t\end{matrix} \} + {\sum }_{k = 1}^{K} {\sum }_{l = k + 1}^{K} exp \{ \begin{matrix}- j ( {φ}_{k , m , n} + {φ}_{l , m , n} ) + \\ 2 jπ ( {f}_{k} + {f}_{l} ) t\end{matrix} \} \\ ( m = 1 , 2 , … , M , n = 1 , 2 , … , M ) & ( 11 )\end{matrix}$$

When Expression (11) is compared with Expression (6), it is understood that not only the frequency difference component fₖ−f₁ (k, 1=1, 2, . . . , K) of the second term and the third term at the right hand of the expression, but also the frequency sum component fₖ+f₁ (k, 1=1, 2, . . . , K) of the fifth term and the sixth term are included.

As described above, according to this embodiment, the frequency sum component is added to the evaluation function in addition to the frequency difference component, which increases the number of frequency components to be included. For this reason, it can be expected that the phase uncertainty be advantageously excluded, and the arrival time difference can be estimated with higher precision.

### Embodiment 4

In Embodiment 1, the arrival time difference is estimated with Expression (1) having the sensitivity in the phase difference of the frequency difference as the evaluation function. On the other hand, in this embodiment, the arrival time difference is estimated with the following Expression (12) as the evaluation function instead of Expression (1).

$$\begin{matrix}[ Ex . 12 ] & \\ {F}_{m , n} ( t ) = {\vert \begin{matrix}1 + {{\sum }_{k = 1}}^{K} exp ( - j {φ}_{k , m , n} + 2 jπ {f}_{k} t ) + \\ {\sum }_{k = 1}^{K} exp ( j {φ}_{k , m , n} - 2 jπ {f}_{k} t )\end{matrix} \vert}^{2} \\ ( m = 1 , 2 , … , M , n = 1 , 2 , … , M ) & ( 12 )\end{matrix}$$

Since all of parts other than the arrival time difference estimation are identical with those in Embodiment 1, their description is omitted.

Then, the advantages of this embodiment are described. Expression (12) can be developed as the following Expression (13).

$$\begin{matrix}[ Ex . 13 ] & \\ {F}_{m , n} ( t ) = 2 K + 1 + {\sum }_{k = 1}^{K} {\sum }_{l = k + 1}^{K} exp \{ \begin{matrix}j ( {φ}_{k , m , n} - {φ}_{l , m , n} ) - \\ 2 jπ ( {f}_{k} - {f}_{l} ) t\end{matrix} \} + {\sum }_{k = 1}^{K} {\sum }_{l = k + 1}^{K} exp \{ \begin{matrix}- j ( {φ}_{k , m , n} - {φ}_{l , m , n} ) + \\ 2 jπ ( {f}_{k} - {f}_{l} ) t\end{matrix} \} + {\sum }_{k = 1}^{K} {\sum }_{l = k + 1}^{K} exp \{ \begin{matrix}j ( {φ}_{k , m , n} + {φ}_{l , m , n} ) - \\ 2 jπ ( {f}_{k} + {f}_{l} ) t\end{matrix} \} + {\sum }_{k = 1}^{K} {\sum }_{l = k + 1}^{K} exp \{ \begin{matrix}- j ( {φ}_{k , m , n} + {φ}_{l , m , n} ) + \\ 2 jπ ( {f}_{k} + {f}_{l} ) t\end{matrix} \} + {\sum }_{k = 1}^{K} exp \{ {jφ}_{k , m , n} - 2 jπ {f}_{k} t \} + {\sum }_{k = 1}^{K} exp \{ - {jφ}_{k , m , n} + 2 jπ {f}_{k} t \} \\ ( m = 1 , 2 , … , M , n = 1 , 2 , … , M ) & ( 13 )\end{matrix}$$

When Expression (13) is compared with Expression (6), it is understood that not only the frequency difference component fₖ−f₁ (k, 1=1, 2, . . . , K) of the third term and the forth term at the right hand of the expression, but also the frequency sum component fₖ+f₁ (k, 1=1, 2, . . . , K) of the fifth term and the sixth term and the direct carrier frequency component fₖ (k=1, 2, . . . , K) of the seventh term and the eighth term are included.

As described above, according to this embodiment, the frequency sum component and the direct carrier frequency component are added to the evaluation function in addition to the frequency difference component, which increases the number of frequency components to be included. For this reason, it is expected that the phase uncertainty be advantageously excluded, and the arrival time difference can be estimated with higher precision.

What is claimed is:

1. The positioning system, comprising:
a radio source for transmitting radio waves each having a plurality of different frequencies;
a plurality of receivers for receiving radio waves from the radio source, the positions of the plurality of receivers being known;
phase difference calculating means for calculating phase differences of the received radio waves of the respective frequencies between the respective receivers;
arrival time difference calculating means for calculating arrival time differences between the respective receivers from each of the phase differences of the respective frequencies calculated by the phase difference calculating means; and
positioning calculating means for calculating the positioning of the radio source from a combination of the arrival time differences calculated by the arrival time difference calculating means,
wherein the plurality of different transmit frequencies from the radio source comprise frequencies arranged such that a frequency difference of two frequency waves arbitrarily selected is an integral multiple of a smallest frequency difference, the frequency difference does not overlap with the frequency difference of two frequency waves of other combinations, and a largest frequency difference of the frequency difference is narrowest.

2. The positioning system according to claim 1, wherein the radio source transmits radio waves by sequentially changing the frequency thereof over a plurality of transmit frequencies.

3. The positioning system according to claim 1, wherein the arrival time difference calculating means calculates, with a square of an absolute value of a phase vector sum of a difference between the calculated phase difference of the respective transmit frequencies and a phase difference obtained by a product of an arbitrarily set estimation arrival time difference and the transmit frequency between the respective receivers as a first evaluation function, and the estimation arrival time difference that maximizes the first evaluation function as an arrival time difference.

4. The positioning system according to claim 2, wherein the arrival time difference calculating means calculates, with a square of an absolute value of a phase vector sum of a difference between the calculated phase difference of the respective transmit frequencies and a phase difference obtained by a product of an arbitrarily set estimation arrival time difference and the transmit frequency between the respective receivers as a first evaluation function, and the estimation arrival time difference that maximizes the first evaluation function as an arrival time difference.

5. The positioning system according to claim 1, wherein the arrival time difference calculating means calculates, with a square of an absolute value of a sum of a phase vector sum and 1 of a difference between the calculated phase difference of the respective transmit frequencies and a phase difference obtained by a product of an arbitrarily set estimation arrival time difference and the transmit frequency between the respective receivers as a first evaluation function, and the estimation arrival time difference that maximizes the first evaluation function as an arrival time difference.

6. The positioning system according to claim 2, wherein the arrival time difference calculating means calculates, with a square of an absolute value of a sum of a phase vector sum and 1 of a difference between the calculated phase difference of the respective transmit frequencies and a phase difference obtained by a product of an arbitrarily set estimation arrival time difference and the transmit frequency between the respective receivers as a first evaluation function, and the estimation arrival time difference that maximizes the first evaluation function as an arrival time difference.

7. The positioning system according to claim 1, wherein the arrival time difference calculating means calculates, with a square of an absolute value of a phase vector sum and a sum of a complex conjugate of the phase vector sum, of a difference between the calculated phase difference of the respective transmit frequencies and a phase difference obtained by a product of an arbitrarily set estimation arrival time difference and the transmit frequency between the respective receivers as a first evaluation function, and the estimation arrival time difference that maximizes the first evaluation function as an arrival time difference.

8. The positioning system according to claim 2, wherein the arrival time difference calculating means calculates, with a square of an absolute value of a phase vector sum and a sum of a complex conjugate of the phase vector sum, of a difference between the calculated phase difference of the respective transmit frequencies and a phase difference obtained by a product of an arbitrarily set estimation arrival time difference and the transmit frequency between the respective receivers as a first evaluation function, and the estimation arrival time difference that maximizes the first evaluation function as an arrival time difference.

9. The positioning system according to claim 1, wherein the arrival time difference calculating means calculates, with a square of an absolute value of a phase vector sum and a sum of 1 and a complex conjugate of the phase vector sum, of a difference between the calculated phase difference of the respective transmit frequencies and a phase difference obtained by a product of an arbitrarily set estimation arrival time difference and the transmit frequency between the respective receivers as a first evaluation function, and the estimation arrival time difference that maximizes the first evaluation function as an arrival time difference.

10. The positioning system according to claim 2, wherein the arrival time difference calculating means calculates, with a square of an absolute value of a phase vector sum and a sum of 1 and a complex conjugate of the phase vector sum, of a difference between the calculated phase difference of the respective transmit frequencies and a phase difference obtained by a product of an arbitrarily set estimation arrival time difference and the transmit frequency between the respective receivers as a first evaluation function, and the estimation arrival time difference that maximizes the first evaluation function as an arrival time difference.

11. The positioning system according to claim 3, wherein the arrival time difference calculating means calculates a plurality of arrival time difference candidates from a plurality of maximums of the first evaluation function, obtains, in relation to arrival time differences between three receivers, a difference between a sum of an arrival time difference candidate of a first receiver and a second receiver and an arrival time difference candidate of the second receiver and a third receiver and the arrival time difference candidate of the first receiver and the third receiver, and calculates, with a square sum of the difference in all the combinations of the three receivers as a second evaluation function, a combination of the arrival time difference candidates that minimizes the second evaluation function, and the positioning calculating means calculates positioning of the radio source from the combination of the arrival time difference candidates.

12. The positioning system according to claim 4, wherein the arrival time difference calculating means calculates a plurality of arrival time difference candidates from a plurality of maximums of the first evaluation function, obtains, in relation to arrival time differences between three receivers, a difference between a sum of an arrival time difference candidate of a first receiver and a second receiver and an arrival time difference candidate of the second receiver and a third receiver and the arrival time difference candidate of the first receiver and the third receiver, and calculates, with a square sum of the difference in all the combinations of the three receivers as a second evaluation function, a combination of the arrival time difference candidates that minimizes the second evaluation function, and the positioning calculating means calculates positioning of the radio source from the combination of the arrival time difference candidates.

13. The positioning system according to claim 5, wherein the arrival time difference calculating means calculates a plurality of arrival time difference candidates from a plurality of maximums of the first evaluation function, obtains, in relation to arrival time differences between three receivers, a difference between a sum of an arrival time difference candidate of a first receiver and a second receiver and an arrival time difference candidate of the second receiver and a third receiver and the arrival time difference candidate of the first receiver and the third receiver, and calculates, with a square sum of the difference in all the combinations of the three receivers as a second evaluation function, a combination of the arrival time difference candidates that minimizes the second evaluation function, and the positioning calculating means calculates positioning of the radio source from the combination of the arrival time difference candidates.

14. The positioning system according to claim 6, wherein the arrival time difference calculating means calculates a plurality of arrival time difference candidates from a plurality of maximums of the first evaluation function, obtains, in relation to arrival time differences between three receivers, a difference between a sum of an arrival time difference candidate of a first receiver and a second receiver and an arrival time difference candidate of the second receiver and a third receiver and the arrival time difference candidate of the first receiver and the third receiver, and calculates, with a square sum of the difference in all the combinations of the three receivers as a second evaluation function, a combination of the arrival time difference candidates that minimizes the second evaluation function, and the positioning calculating means calculates positioning of the radio source from the combination of the arrival time difference candidates.

15. The positioning system according to claim 7, wherein the arrival time difference calculating means calculates a plurality of arrival time difference candidates from a plurality of maximums of the first evaluation function, obtains, in relation to arrival time differences between three receivers, a difference between a sum of an arrival time difference candidate of a first receiver and a second receiver and an arrival time difference candidate of the second receiver and a third receiver and the arrival time difference candidate of the first receiver and the third receiver, and calculates, with a square sum of the difference in all the combinations of the three receivers as a second evaluation function, a combination of the arrival time difference candidates that minimizes the second evaluation function, and the positioning calculating means calculates positioning of the radio source from the combination of the arrival time difference candidates.

16. The positioning system according to claim 8, wherein the arrival time difference calculating means calculates a plurality of arrival time difference candidates from a plurality of maximums of the first evaluation function, obtains, in relation to arrival time differences between three receivers, a difference between a sum of an arrival time difference candidate of a first receiver and a second receiver and an arrival time difference candidate of the second receiver and a third receiver and the arrival time difference candidate of the first receiver and the third receiver, and calculates, with a square sum of the difference in all the combinations of the three receivers as a second evaluation function, a combination of the arrival time difference candidates that minimizes the second evaluation function, and the positioning calculating means calculates positioning of the radio source from the combination of the arrival time difference candidates.

17. The positioning system according to claim 9, wherein the arrival time difference calculating means calculates a plurality of arrival time difference candidates from a plurality of maximums of the first evaluation function, obtains, in relation to arrival time differences between three receivers, a difference between a sum of an arrival time difference candidate of a first receiver and a second receiver and an arrival time difference candidate of the second receiver and a third receiver and the arrival time difference candidate of the first receiver and the third receiver, and calculates, with a square sum of the difference in all the combinations of the three receivers as a second evaluation function, a combination of the arrival time difference candidates that minimizes the second evaluation function, and the positioning calculating means calculates positioning of the radio source from the combination of the arrival time difference candidates.

18. The positioning system according to claim 10, wherein the arrival time difference calculating means calculates a plurality of arrival time difference candidates from a plurality of maximums of the first evaluation function, obtains, in relation to arrival time differences between three receivers, a difference between a sum of an arrival time difference candidate of a first receiver and a second receiver and an arrival time difference candidate of the second receiver and a third receiver and the arrival time difference candidate of the first receiver and the third receiver, and calculates, with a square sum of the difference in all the combinations of the three receivers as a second evaluation function, a combination of the arrival time difference candidates that minimizes the second evaluation function, and the positioning calculating means calculates positioning of the radio source from the combination of the arrival time difference candidates.
